(19) United States
(12) Patent Application Publication
(10) Pub. No.: US 2010/0298502 A1
(43) Pub. Date: Nov. 25, 2010

(54) MODIFICATION OF POLYOLEFINS

(75) Inventors: Graeme Moad, Sassafras (AU); Michael Shane O'Shea, Mulgrave (AU); Gary Peeters, Cranbourne (AU); Almar Postma, Balwyn (AU)

Correspondence Address: FISH & RICHARDSON P.C., PO BOX 1022, MINNEAPOLIS, MN, 55440-1022, US

(73) Assignee: ADVANCED POLYMERIK PTY LTD a company

(21) Appl. No.: 12/670,330

(22) PCT Filed: Jul. 23, 2008
(86) PCT No.: PCT/AU2008/001060

§ 371 Date: Aug. 3, 2010

(30) Foreign Application Priority Data
Jul. 23, 2007 (AU) 2007903959
May 30, 2008 (AU) 2008902734

(51) Int. Cl. C08F 8/00

(52) U.S. Cl. 525/371; 525/360; 525/370

(57) ABSTRACT

The invention provides a process for increasing the melt flow index of a polyolefin, the process comprising using a melt mixing device to melt mix the polyolefin in contact with oxygen and a transition metal catalyst having a redox potential ranging from 0 to 2 volts, wherein oxygen is introduced to the melt mixing device, and wherein the transition metal catalyst in contact with the polyolefin forms at least part of a component of the melt mixing device.

### FIELD OF THE INVENTION

The present invention in general relates to a process of modifying polyolefins. In particular, the invention relates to a process of increasing the melt flow index (MFI) of polyolefins.

### BACKGROUND OF THE INVENTION

Polyolefins are used widely throughout the world in a diverse range of applications such as agriculture, construction, fibre technology, health and hygiene, and packaging. Common polyolefins include polyethylene and polypropylene.

Polyolefins such as polyethylene and polypropylene are generally manufactured in large scale reactors. Depending upon their intended application, a given polyolefin may be manufactured in different grades such that it exhibits a variety of processing properties. For example, polyethylene may be manufactured with a relatively low MFI (typically characterised by a high average molecular weight and a broad molecular weight distribution) for use in blow-moulding applications, or with a relatively high MFI (typically characterised by a lower average molecular weight and a narrower molecular weight distribution) for use in injection moulding applications.

However, there is generally insufficient flexibility in large scale manufacturing operations to prepare the numerous grades of polyolefins required by downstream converters. Some grades of polyolefins are therefore produced by tailored post-reactor modification processes using a base resin that is produced on mass. For example, polyolefins such as polypropylene may be reacted with organic peroxides in a post-reactor modification melt mixing process to prepare grades of polypropylene having a higher MFI and lower polydispersity than the base resin. Such modification techniques typically result in the chemical modification of the polymer and/or structural modification of the polymer chains.

While other processes have been developed for producing post-reactor modified polyolefins, an opportunity remains to address or ameliorate one or more disadvantages or shortcomings associated with existing processes, or to at least provide a useful alternative process.

### SUMMARY OF THE INVENTION

The present invention provides a process for increasing the melt flow index of a polyolefin, the process comprising using a melt mixing device to melt mix the polyolefin in contact with oxygen and a transition metal catalyst having a redox potential ranging from 0 to 2 volts, wherein the oxygen is introduced to the melt mixing device, and wherein the transition metal catalyst in contact with the polyolefin forms at least part of a component of the melt mixing device.

The use of transition metal catalysts to promote an increase in the MFI of certain classes of polyolefins is known. However, as with the use of organic peroxides, the catalysts are typically used in the form of an additive that is introduced to and melt mixed with a polyolefin in a melt mixing device such as an extruder. Although useful for increasing the MFI of polyolefins, such methodology inherently produces catalyst residue (or organic peroxide residue) in the resulting modified polyolefin, and can also be limited by the degree to which the MFI can be increased.

It has now been found that a transition metal catalyst that forms at least part of a component of a melt mixing device can function, in combination with oxygen, to promote an effective and efficient increase in the MFI of a polyolefin. In particular, it has been found that the MFI of a polyolefin may be increased by melt mixing the polyolefin in contact with oxygen and the component comprising the transition metal catalyst. Despite forming at least part of a component of the device, the transition metal catalyst surprisingly has sufficient activity, in combination with the oxygen, to promote chain scission of the polyolefin and thereby increase its MFI.

Where the melt mixing device is a screw extruder, the component comprising the transition metal catalyst may, for example, form part or all of the screw.

By virtue of the transition metal catalyst forming at least part of a component of the melt mixing device, it will be appreciated that little or no catalyst residue is transferred into the resulting modified polyolefin.

Further aspects of the invention are described in more detail below.

### BRIEF DESCRIPTION OF THE DRAWINGS

The invention will also be described herein with reference to the following non-limiting drawings in which:

FIG. 1 illustrates the effect of copper and injected air (6.2 L/min) on the molecular weight distribution of HD5148 and H1.

FIG. 2 illustrates the effect of brass elements (with injected air) on the MFI of HD5148.

FIG. 3 illustrates the effect of increasing airflow rate for materials extruded with copper containing elements.

FIG. 4 illustrates the effect of increasing airflow rate with all steel elements.

FIG. 5 illustrates the effect of shear rate on the MFI of HD5148.

FIG. 6 illustrates the effect of temperature on MFI of HD5148/H1 with copper and steel.

FIG. 7 illustrates the effect of feed rate MFI of HD5148 and H1.

FIG. 8 illustrates the comparison of impact strength of reactively extruded HD5148 as a function of air injection rate (24 brass elements/400 rpm/20 kg/hr/220° C.). Injection moulding grade HDPE (ET6099) included for comparison.

FIG. 9 illustrates the comparison of impact strength of reactively extruded H1 as a function of air injection rate (24 brass elements/400 rpm/20 kg/hr/220° C.). Injection moulding grade HDPE (ET6099) included for comparison.

### DETAILED DESCRIPTION OF THE INVENTION

The invention may be used to increase the MFI of a polyolefin, and may be used to narrow the polydispersity of a polyolefin, so as to produce a modified polyolefin grade that exhibits appropriate processing and other properties for the intended application.

As used herein, the term “polyolefin” is intended to mean a polymer or copolymer of ethylene, propylene, butenes and other unsaturated aliphatic hydrocarbons, vinyl esters (e.g. vinyl acetate), or (meth)acrylics (e.g. butyl acrylate, acrylic acid). Generally, the polyolefin will be a polymer of ethylene, propylene or copolymer thereof, or a copolymer of ethylene or propylene with one or more C₄-C₁₂ α-olefin aliphatic comonomers. The polyolefin used will be chain scissionable. By being “chain scissionable” is meant that the polyolefin can undergo scission reactions that give rise to an increase in the polyolefins MFI.

The polyolefin may be virgin polymer (i.e. post-reactor) or waste polymer (i.e. post-consumer).

In one embodiment the polyolefin is a polyethylene homopolymer, copolymer or blend containing one or more polyethylene homopolymers and/or copolymers.

The polyethylene may be low density polyethylene (LDPE), linear low density polyethylene (LLDPE), ultra-low density polyethylene (ULDPE), medium density polyethylene (MDPE), or high density polyethylene (HDPE).

Grades of polyethylene suitable for use in high melt strength converting techniques such as blow moulding and extrusion generally have a relatively broad polydispersity (e.g. >6). These polymers generally have relatively poor impact resistance. In contrast, grades of polyethylene used in high melt flow converting techniques such as injection moulding typically have a narrower polydispersity (e.g. <4 and >2). These polymers generally exhibit good impact resistance.

HDPE generally has a density of about 0.941 g/cm³ or greater. HDPE may be a homopolymer, but it is more commonly manufactured as a copolymer of ethylene and small quantities of one or more α-olefin comonomers such as butene, hexene, 4-methyl-1-pentene and octene. Such α-olefin comonomers are generally used to introduce short chain branches into the polyethylene polymer chain structure so as to reduce the crystallinity of the polymer and, in turn, increase its impact strength and reduce its stiffness.

The relatively low melting point and chemical inertness of HDPE lends itself to conventional polymer converting techniques such as extrusion, injection moulding and blow moulding. Blow moulding and injection moulding in packaging applications are by far the largest uses of HDPE polymers. Due to its inertness and absence of toxicity, HDPE is used in the production of food containers, milk bottles, housewares and toys. It is also used to make crates, pails, pipes and films.

Primarily due to its relatively low MFI, generally less than about one third of the HDPE used to make blow moulded bottles is recycled. In particular, post-consumer blow-moulding grade HDPE is generally recycled by blending it with virgin injection moulding grade HDPE. However, such recycling is generally limited to using a maximum of about 30 weight % blow moulding grade post-consumer HDPE due to the polymers low MFI characteristics which give rise to the need for higher processing temperatures and pressures, the effect of which can render such processing impractical and/or uneconomical. Blending of post-consumer blow moulding grade HDPE with virgin injection moulding grade HDPE can also potentially lead to materials that exhibit reduced impact and stress cracking resistance.

The process in accordance with the invention can advantageously be used to increase the MFI of blow moulding grade HDPE, for example post-consumer blow moulding grade HDPE, such that it can be more effectively and efficiently blended with injection moulding grade HDPE. In particular, increasing the MFI of the post-consumer blow moulding grade HDPE enables the polymer to be more readily processed using techniques such as injection moulding at reduced pressures, temperatures and cycle times. Such a reduction in costly processing parameters makes using the modified HDPE economically attractive, especially in those processing applications using large amounts of polymer such as in the production of injection moulded mobile garbage receptacles and curb side recycle collection crates. Thus, the process in accordance with the invention can be used as a means for increasing the amount of post-consumer blow moulding grade HDPE that is currently being recycled.

Where polyethylene is used in accordance with the invention, it may have a density ranging from about 0.918 to about 0.970 g/cm³. Where the polyethylene is a copolymer, it may be a statistical copolymer of ethylene and generally no more than about 10% w/w, or no more than about 5% w/w comonomer.

The polyolefin used in accordance with the invention also includes polypropylene homopolymers, copolymers and blends containing one or more polypropylene homopolymers and/or copolymers.

Suitable polypropylene homopolymers include isotactic polypropylene, atactic polypropylene and syndiotactic polypropylene.

Polypropylene copolymers include copolymers of propylene and other monomers in an amount that will generally be determined by the intended application of the modified polymer. In one embodiment, the polypropylene copolymers include copolymers of propylene and other monomers in an amount up to about 0.1% wt/wt to about 10% wt/wt. In one embodiment, the polypropylene copolymer is a copolymer of propylene and ethylene.

Suitable polypropylene copolymers also include copolymers of propylene and one or more C₄-C₁₂ α-olefin aliphatic comonomers. The α-olefin content of the copolymers may range from about 0.1% wt/wt to about 10% wt/wt. Specific α-olefin aliphatic comonomers include, 1-butene, 1-pentene, and 1-hexene.

Increasing the MFI of polypropylene homopolymers or copolymers can give rise to similar processing advantages to those discussed above in respect of polyethylene.

In one embodiment, the polyolefins have a relatively high molecular weight and a broad molecular weight distribution (i.e. a low MFI) and comprise a high proportion of homopolymer of either ethylene or propylene.

In the case of ethylene derived polymers, the presence of at least some internal unsaturation resulting from the catalyst system used in production may provide for an increased efficiency of increasing the MFI of the polymer.

The present invention provides a process for increasing the MFI of a polyolefin. MFI values referred to herein are those determined according to ASTM D1238 at a temperature of 190° C. with a ram weight of 2.16 kg. MFI measurements reported herein were conducted using an Extrusion plastometer (Melt Indexer).

Those skilled in the art will appreciate that the simple effects of shear and temperature can promote a limited degree of chain scission during melt mixing of polyolefins that may give rise to a limited increase in its MFI. The MFI of the polyolefin may be further increased by bringing the molten polyolefin into contact with oxygen or a transition metal catalyst during melt mixing.

It has now been found that by melt mixing the polyolefin in contact with oxygen and a transition metal catalyst that the MFI of the polyolefin may be increased more effectively and efficiently than under the same conditions in the absence of oxygen and the transition metal catalyst or under the same conditions in the absence of oxygen or the transition metal catalyst. In other words, the combination of oxygen and a transition metal catalyst is believed to potentiate an increase in the MFI of the polyolefin. In some cases, the increase in MFI can be achieved more rapidly compared with conventional processes. Furthermore, the MFI increase can advantageously be achieved without the need to introduce additives such as peroxides or transition metal catalyst during the process.

There is no particular limitation regarding the amount by which the MFI of the polyolefin may be increased. The increase in MFI that is to be achieved will generally be dictated by the intended application of the resulting modified polyolefin.

The process in accordance with the invention advantageously enables the increase in MFI of the polyolefin to be effectively and efficiently controlled. In particular, by controlling process parameters such as residence time, shear, temperature and oxygen content (e.g. via a gas flow rate), the polyolefin can be melt mixed so as to achieve a desired increase in its MFI.

Generally, the MFI of the polyolefin will be increased by at least about 5%, for example, at least about 25%, or at least about 50%, or at least about 100%, or at least about 500%.

Where the polyolefin used in accordance with the invention is post-consumer blow moulding grade HDPE, which generally has an MFI of about 0.6 g/10 min (at 190° C./2.16 kg), the process in accordance with the invention may be used to increase the MFI of the polymer to at least about 3.5 g/10 min (at 190° C./2.16 kg). Increasing the MFI of the HDPE from about 0.6 g/10 min to at least 3.5 g/10 min will generally increase the polymers processability in injection moulding applications.

The process in accordance with the invention comprises melt mixing the polyolefin in contact with oxygen and a transition metal catalyst using a melt mixing device. By being melt mixed “in contact with oxygen and a transition metal catalyst” is meant that the polyolefin in a molten state physically makes contact with both oxygen and the transition metal catalyst.

Provided that the polyolefin can be melt mixed in contact with oxygen and the transition metal catalyst, there is no particular limitation on the type of melt mixing device that may be used in accordance with the invention. Suitable melt mixing devices include continuous and batch mixes. For example, the melt mixing device may be an extruder such a single screw or twin screw extruder, a static mixer, a cavity transfer mixer, or combinations of two or more such devices. Melt mixing may be conducted in single or multiple steps.

Where the melt mixing device is a twin screw extruder, melt mixing may be conducted in either co- or counter-rotating modes. In some embodiments, it may be desirable to perform the melt mixing in intermeshing co-rotating mode.

The melt mixing process will be conducted at a temperature that is at least sufficient to cause the polyolefin to remain in a molten state. Those skilled in the art will appreciate that such temperatures will vary depending upon the type of polyolefin being melt mixed. Generally, the melt mixing will be performed at a temperature ranging from about 170° C. to about 320° C., for example at about 200° C. to about 260° C.

For polyolefins derived predominantly from ethylene, process temperatures will generally be in the range 250-280° C. For polymers derived from polypropylene or an α-olefin, process temperatures will generally be in the range 170-200° C. Higher process temperatures may promote further scission but this will generally be at the expense of some product discolouration. Thus the lowest temperature sufficient to bring about the desired degree of scission will generally be preferred.

The transition metal catalyst used in accordance with the invention has a redox potential ranging from 0 to 2 volts (V), for example from about 0.2 to about 1 V. As used herein “redox potential” (also commonly referred to as “reduction potential”) is a potential defined relative to a standard hydrogen electrode (SHE) which is in the art arbitrarily given a potential of 0 volts. The transition metal catalyst may be in the form of a transition metal per se (i.e. in its metallic state) or a salt thereof. When in its metallic state, the transition metal may be employed as an alloy with one or more other metals.

Without wishing to be limited by theory, it is believed that transition metal catalysts having a redox potential within the range of 0-2 V can effectively function during the process of the invention as a reductant to promote 13-scission reactions. It is the 13-scission reactions that ultimately give rise to an increase in the MFI of the polyolefin.

In addition to promoting an increase in the MFI of the polyolefin, the process in accordance with the invention may also promote a decrease in the polydispersity of the polyolefin. In particular, chain scission promoted by the process is believed to cause the molecular weight distribution of the polymer chains to approach the most probable distribution having a ratio of weight average to number average molecular weight of about 2.

In accordance with the invention, oxygen is required to be “introduced” to the melt mixing device. By being “introduced” is meant that oxygen is physically forced into the melt mixing device. This is intended to be in contrast to the situation where ambient oxygen may enter the melt mixing device under standard processing conditions for example with the feedstock.

There is no particular limitation on how the oxygen is to be introduced to the melt mixing device so as to make contact with the polyolefin during melt mixing. For example, the source of oxygen may be oxygen gas or an oxygen-containing gas mixture such as air or a mixture of oxygen and nitrogen, and the gas may be introduced under pressure via an appropriate injection port of the melt mixing device using a compressed gas cylinder or a pump such as a syringe pump. In that case, the gas might be introduced at a flow rate from 2 to 70 L/kg of polyolefin being processed, for example from 10 to 60 L/kg of polyolefin being processed. In the examples of the invention that follow, with the specific extruder used, a flow rate range of 2.1 L/min to 6.2 L/min is equivalent to a flow rate range of from 6.2 to 18.7 L/kg of polyolefin being processed.

Where the melt mixing device is of a type that enables oxygen to be introduced to the polyolefin melt at a separate location from where the transition metal catalyst makes contact with the polyolefin melt (e.g. as in an extruder), the oxygen will generally be introduced such that it makes contact with the molten polyolefin before (i.e. up stream of where) the transition metal catalyst makes contact with the polyolefin melt. Alternatively, the oxygen may be introduced such that it makes contact with the molten polyolefin at the same location as, and at the same time when, the transition metal catalyst makes contact with the polyolefin melt. In other words, the process of the invention will generally comprise melt mixing the polyolefin in contact with oxygen and a transition metal catalyst whereby polyolefin that makes contact with the transition metal catalyst has previously made, or simultaneously makes, contact with the oxygen.

It may be desirable to remove any pressurised gas within the melt resulting from the introduction of the oxygen by venting the melt through an appropriate port of the device prior to the melt exiting the device. Those skilled in the art can readily configure a melt mixing device to achieve this result.

The transition metal catalyst used in accordance with the invention “forms at least part of a component” of the melt mixing device. By “forms at least part of a component” is meant that the transition metal catalyst constitutes at least part of the components structure (i.e. the component comprises the transition metal catalyst). For example, the component may be made in part or in full of a suitable transition metal or an alloy thereof, or the transition metal or an alloy thereof may be bound to at least part of the component in some way, for example by being coated or plated with the transition metal or an alloy thereof. Alternatively, a suitable transition metal salt may form part of a ceramic composition that is used to make in part or in full or coat at least part of a component of the melt mixing device.

Providing a suitable transition metal in the form of an alloy with one or more other metals may be desirable in that the alloy may have improved properties relative to the transition metal alone, such as reduced susceptibility to oxidation and/or improved hardness.

As the transition metal catalyst is required to contact the molten polyolefin during melt mixing, it will be appreciated that at least part of the component or its coated or plated surface comprising the transition metal catalyst will also be in contact with the molten polyolefin during melt mixing.

The component comprising the transition metal catalyst may be a fixed or moving component of the device. The component may be a part of the original design of the device, or the component may be a modified version of such a part. The component may also be a non-original part of the device (i.e. it has been added to the original design of the device).

In some embodiments, the transition metal catalyst will be in the form a transition metal (i.e. in its metallic state). Suitable transition metals that may be used in accordance with the invention include, but are not limited to, copper and silver. Suitable alloys comprising the transition metal include, but are not limited to, brass (i.e. copper and zinc) and bronze (i.e. copper and tin).

Provided that the component allows the transition metal catalyst to come into contact with the molten polyolefin and can withstand the melt processing environment, there is no particular limitation on (a) what type of material the component can be made of, and (b) what form the component may take.

In one embodiment, the component is a metal component of the melt mixing device.

The form that the component takes will to some extent be dictated by the type of melt mixing device being used. For example, the component comprising the transition metal catalyst may form part or all of one or more of the mixing element(s), die element(s), or barrel section(s) of the melt mixing device.

Where the melt mixing device is an extruder, the component comprising the transition metal catalyst may be conveniently provided in the form of part or all of the screw of the extruder, for example one or more of the screw elements of the screw may be a metal component comprising a suitable transition metal or alloy thereof. Where the screw does not have separate screw elements, the entire screw or part thereof may be made from, coated or plated with the transition metal or alloy thereof.

In some embodiments of the invention, the component comprising the transition metal catalyst is made of, coated or plated with brass or bronze. For example, an extruder may be provided with a screw (or part thereof) made of, coated or plated with brass or bronze, or a screw having one or more brass or bronze or brass or bonze coated or plated screw elements.

Provided that the potentiated effect of using the transition metal catalyst in combination with oxygen is attained, there is no particular limitation on the surface area of the component that needs to make contact with the molten polyolefin. Where the component forms part of a screw of an extruder, the component may, for example, represent from about 0.1% to 25%, or 2% to 10%, of the total screw surface area that makes contact with the molten polyolefin.

Provided that the potentiated effect of using the transition metal or salt thereof in combination with oxygen is attained, there is also no particular limitation on the amount of transition metal catalyst that may be present in the component. Generally, the component will be made from, coated or plated with a suitable transition metal or an alloy thereof. Where an alloy comprising the transition metal is used, the transition metal will generally be present in an amount of at least about 10 wt. %, or at least about 30 wt. %, or at least about 50 wt. %, or at least about 70 wt. %, or at least about 90 wt. %.

Through the control of one or more process parameters such as the residence time of the melt mixed polyolefin, the shear applied to the polyolefin by the melt mixing device, the temperature at which melt mixing is conducted and oxygen pressure applied to the melt mixing device (or concentration of oxygen in the melt), the increase in the MFI of the polyolefin may itself be controlled.

It will be appreciated that any variation in the control of one or more of these process parameters to effect a desired increase in the MFI of the polyolefin will primarily be dictated by the type of polyolefin being used and the desired increase in MFI. Those skilled in the art will be able to control such process parameters to achieve a desired increase in the MFI of a selected polyolefin using a given melt mixing device.

Generally, the residence time of the polyolefin in a melt mixing device when performing the process of the invention will be between about 20 seconds and 200 seconds, for example between 50 and 200 seconds.

Where the source of oxygen used in accordance with the invention is provided in the form of air, the flow rate of the air into the molten polyolefin will generally range from about 2 to about 70 L/kg of the polyolefin being processed, for example from about 10 to about 60 L/kg of the polyolefin being processed.

Generally, the process in accordance with the invention will comprise the steps of:

(a) introducing the polyolefin into the melt mixing device at a temperature sufficient to cause the polyolefin to melt;
(b) introducing oxygen to the melt mixing device;
(c) melt mixing the polyolefin in contact with oxygen and a transition metal catalyst having a redox potential ranging from 0 to 2, wherein the transition metal catalyst in contact with the polyolefin forms at least part of a component of the melt mixing device;
(d) controlling process parameters such as residence time, shear, temperature and concentration of oxygen in the melt or oxygen pressure via the rate of oxygen flow, so as to achieve a desirable melt flow index; and
(e) collecting and cooling the resulting melt mixed product.

The present invention will hereinafter be further described with reference to the following non-limiting examples.

### EXAMPLES

### A. Chain ScissioningH of HDPE

### Experimental Equipment

Twin Screw Extruder—Experiments were conducted using a 30 mm diameter twin screw extruder of L/D ratio 42 operating in the co-rotating intermeshing mode. The HDPE resin was added at controlled rates between 5 and 20 kg/h to the feed throat of the extruder via a gravimetric feeder. Under the conditions used, a 20 kg/h feed rate equates to a residence time of 50 seconds. A feed rate of 5 kg/h equates to residence time of 3.3 minutes.

The twin screw extruder barrel was maintained at a variety of temperature profiles around the range 200° C. to 320° C. The rotational velocity of the screw was varied from 100-400 rpm (25 to 100% of maximum) with the motor current ranging from 12-34 amps (29-81% of maximum). A vacuum port at the end of the barrel was generally operated to vent volatile components.

Under all run conditions the hopper(s) and feed throat were kept under a positive pressure of nitrogen.

The screw elements comprising the transition metal catalyst took the form of eight tooth gear mixing elements each L/D 0.5 that were constructed entirely of brass or were a brass, copper or bronze gear ring mounted on a tool steel insert. The screw elements were located after the point of oxygen injection.

Melt Flow Index (MFI)— MFI measurements were carried out using an Extrusion Plastometer (Melt Indexer) according to the ASTM D1238 standard method. The temperature was fixed at 190° C. with a ram weight of 2.160 kg.

The calculation of MFI is a variation of the capillary viscometer experiment with a standard diameter (2.095 mm) and length (8.00 mm) of a capillary die. After equilibrium is reached in a specific time, the polymer being forced through the die is cut. The MFI is obtained by cutting off lengths of extrudate being forced out of the die over a period of time and weighed after cooling.

Gel Permeation Chromatography (GPC)— Experimental data was collected using a Gel Permeation Chromatograph operating at 140° C. using a 1,2,4-trichlorobenzene (TCB) stabilised with 0.01% w/w 2,6-di-tert-butyl-4-methylphenol (DBPC) mobile phase system. Detection was by refractive index (RI) measurement and Viscometry. A series of three Styragel® columns (HT3 500 −3 ×10⁴ 10³ Å, 2xHT6E 5×10³−1×10⁷ 10⁴, 10⁵ and 10⁶ Å l mixture) were used, being slowly conditioned from toluene to TCB. Molecular weight data for all HDPE samples were derived from a universal calibration plot based on eight mono-disperse polystyrene standards with molecular weights ranging from 3.1×10³ to 2.46×10⁶ in TCB (0.1% w/w DBPC). The calibration sample solutions were filtered through a 0.2 μm teflon filter membrane prior to placing in 10 ml GPC vials for injection.

HDPE samples were prepared in 2 ml and 7 ml 0.5 μm filter vials in TCB (0.1% w/w DBPC) keeping to a concentration of approximately 3 mg/ml. The software used to measure and analyse the data (including calculation of the polydispersity index) was Millenium³³®.

Notched Impact Testing—Standard Izod impact tests on notched specimens were conducted at 20° C. by employing a pendulum type impact tester and according to the ASTM D256 standard.

### Experimental Materials

HDPE HD5148-HD5148 is a virgin blow-moulding grade HDPE produced specifically for milk bottles and similar containers. It is produced on a gas phase reactor using a chromium based catalyst. The nominal MFI is 0.8 g/10 min (at 190°/2.16 kg) and the density of the material is 0.960 g/cm³. It has a relatively broad molecular weight distribution compared to injection moulding grades to provide improved melt strength and processability in blow-moulding applications.
HDPE H1-H1 is produced from HDPE derived from post-consumer kerbside collections. The plastics are separated mainly by automatic IR “finger printing” of the waste and are shredded, washed and subjected to additional separation to produce a relatively pure flake. The flake is then passed through an extrusion line with melt filtration and converted into pellets. While it is predominantly from milk bottles made from HD5148, about 12-15% is from other household and industrial chemical containers which are largely made from slurry process Ziegler-Natta (TiCl₂) catalyst HDPE grades. Contaminates include polypropylene from bottle caps, a range of polymers in labels, pigments and other materials. It has a MFI of about 0.6 g/10 min (190° C./2.16 kg) and a density of 0.960 g/cm³.
HDPE ET6099-Virgin injection moulding grade HDPE with a MFI of around 4.6 g/10 min (at 190° C./2.16 kg) and a density of 0.955 g/cm³.
   Effect of Oxygen and Transition Metal Catalyst The effect of using oxygen (in the form of air) in combination with a transition metal catalyst (in the form of copper) was investigated by conducting a series of experiments with (i) air only (with an air flow rate of 6.2 L/min), (ii) copper only (24 brass elements forming part of the screw) and (iii) air and copper (air flow rate of 6.2 L/min and 24 brass elements). The experiments were conducted with otherwise identical conditions of a feed rate of 20 kg/h (residence time of 50 seconds), an extruder temperature of 220° C. and a screw speed of 400 rpm. The MFI and polydispersity index of the respective materials were determined, with polydispersity being defined as the weight average molecular weight (Mw)/number average molecular weight (Mn).

TABLE 1
Chain scissioning of HD5148 and H1.

| | MFI (190° C./2.16 kg, | | |
|---|---|---|---|
| | g/10 min.) | | |
| Conditions | HD5148 | H1 | ET6099 |
| Starting material | 0.8 | 0.6 | 4.6 |
| Air only (6.2 L/min) | 4.9 | 0.93 | — |
| Copper only (24 elements) | 0.87 | 0.55 | — |
| Air and copper (6.2 L/min, 24 elements) | 16 | 3.7 | — |

TABLE 2
Polydispersity of selected materials

| | Polydispersity | | |
|---|---|---|---|
| Conditions | HD5148 | H1 | ET6099 |
| Starting material | 6.7 | 6.8 | 3.8 |
| Air only (6.2 L/min) | 4.0 | 5.6 | — |
| Copper only (24 elements) | — | — | — |
| Air and copper (6.2 L/min, 24 elements) | 4.2 | 4.9 | — |

Table 1 illustrates that with air and copper the MFI of HD5148 and H1 was increased from 0.8 and 0.6 g/10 min, respectively to 16 and 3.7 g/10 min, respectively. These MFI values are significantly more than those obtained by exposure to air only or copper only, indicating a potentiated effect between the copper and air. The MFI of 3.7 g/10 min obtained for H1 is comparable to the value of 4.6 for ET6099 (ie. the virgin injection moulding grade HDPE).

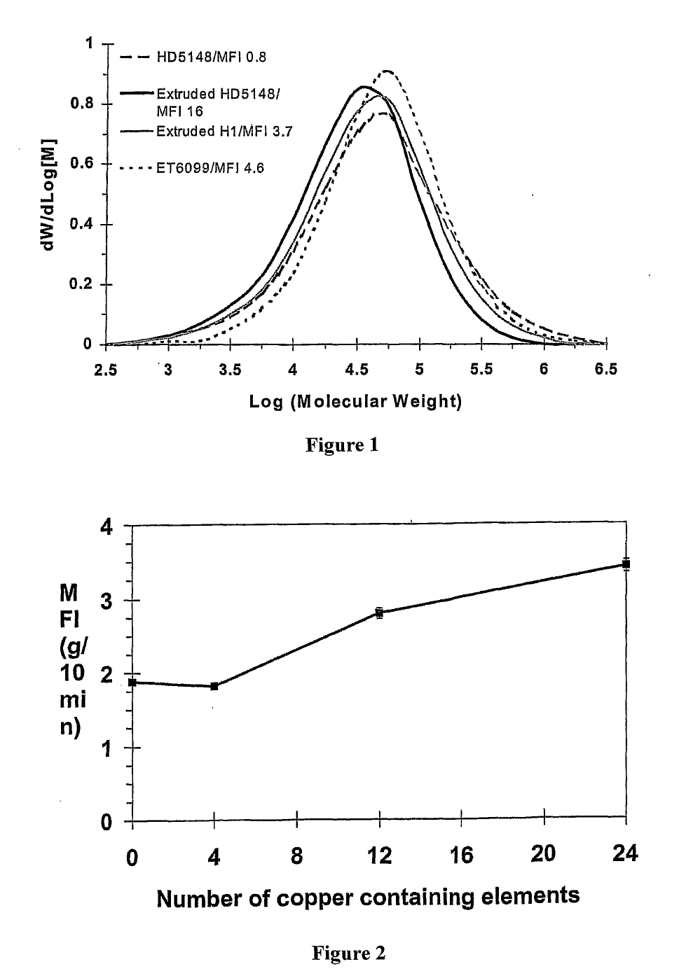

Table 2 illustrates that following reactive extrusion with air and copper, the polydispersity index of HD5148 and H1 was reduced from 6.7 and 6.8, respectively to 4.2 and 4.9 respectively. This data indicates a narrowing of the molecular weight distribution and compare well with the polydispersity index of 3.8 for ET6099. This narrowing of the molecular weight distribution is also illustrated in FIG. 1.

### Effect of Brass Elements

The effect of the number of brass elements on the MFI of HD5148 is illustrated in FIG. 2. The air was injected into the extruder prior to contact of the polyethylene with the brass elements in order to promote maximum chain scissioning. Increasing the number of brass elements served to increase the MFI. The addition of four elements had no significant effect, indicating there is a threshold number of brass elements that must be exceeded before an appreciable reduction in molecular weight occurs. The surface area of 24 brass elements represents 13.7% of the total screw element surface area.

### Effect of Injected Air

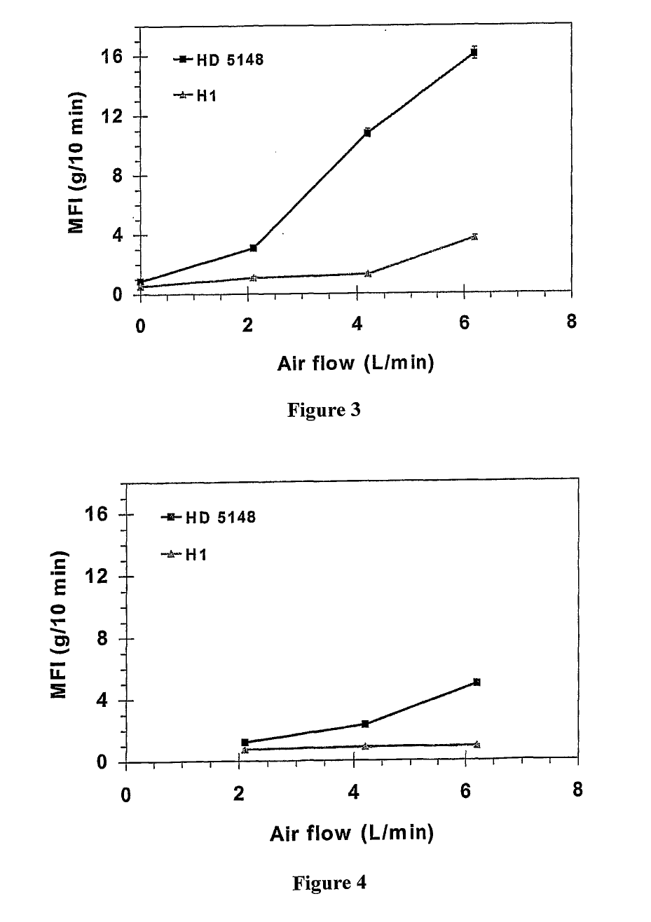

The effect of increased airflow was investigated by changing the airflow from 2.1 to 6.2 L/min and the results of these experiments are shown in FIG. 3. The extruder temperature was 220° C., 24 brass elements were used, the rotational velocity was 400 rpm and the feed rate was 20 kg/h. FIG. 4 shows the effect when an all steel screw was used. Extruder parameters were the same as in FIG. 3.

Investigation of the effect of air on both HD5148 and H1 with brass and steel elements indicated that increasing the airflow, significantly increases the MFI of the resultant materials. The effect observed in respect of HD5148 was more significant than that observed in respect of H1. The effect observed was also significantly larger when brass elements were used.

### Effect of Shear

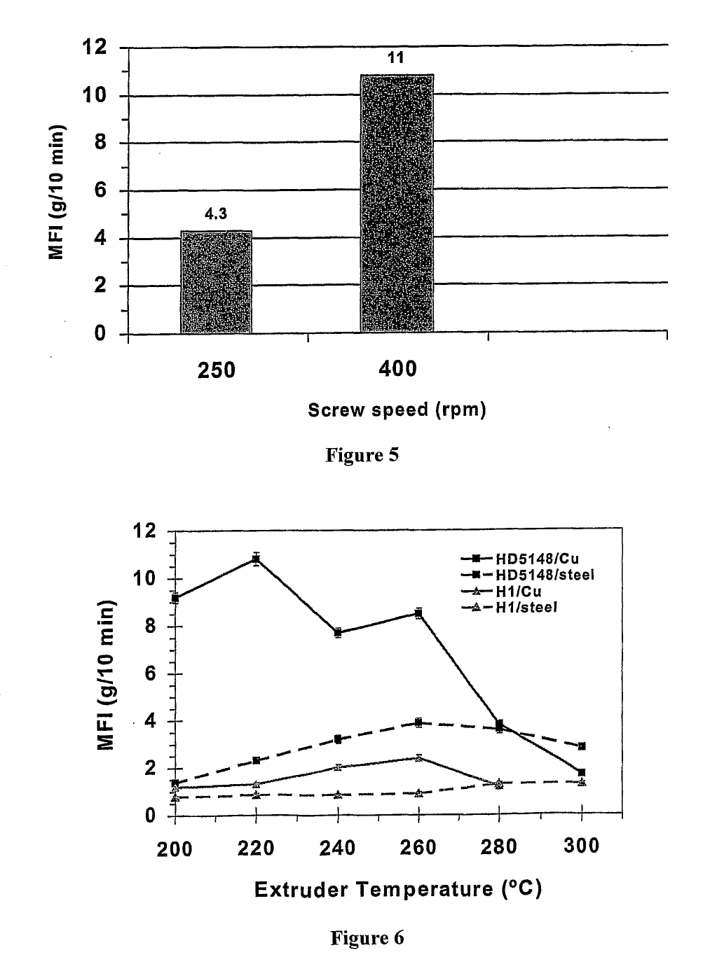

FIG. 5 shows the results of extruder experiments performed on HD5148 at rotational velocities of 250 and 400 rpm (24 brass elements, 4 L/min, 220° C. and 20 kg/h). It can be seen that increasing the shear rate significantly increases the MFI of the polyethylene at the moderate extruder temperature of 220° C.

### Effect of Temperature

FIG. 6 shows the effect of temperature on MFI for both HD5148 and H1 with either 24 brass elements in the screw, or with an all steel screw. The injected air rate was 4 L/min, the feed rate was 20 kg/h and the rotational velocity was 400 rpm. The results with brass elements indicate that the MFI decreases significantly above 260° C. With an all steel screw, some chain scissioning is only noted when using HD5148.

### Effect of Residence Time

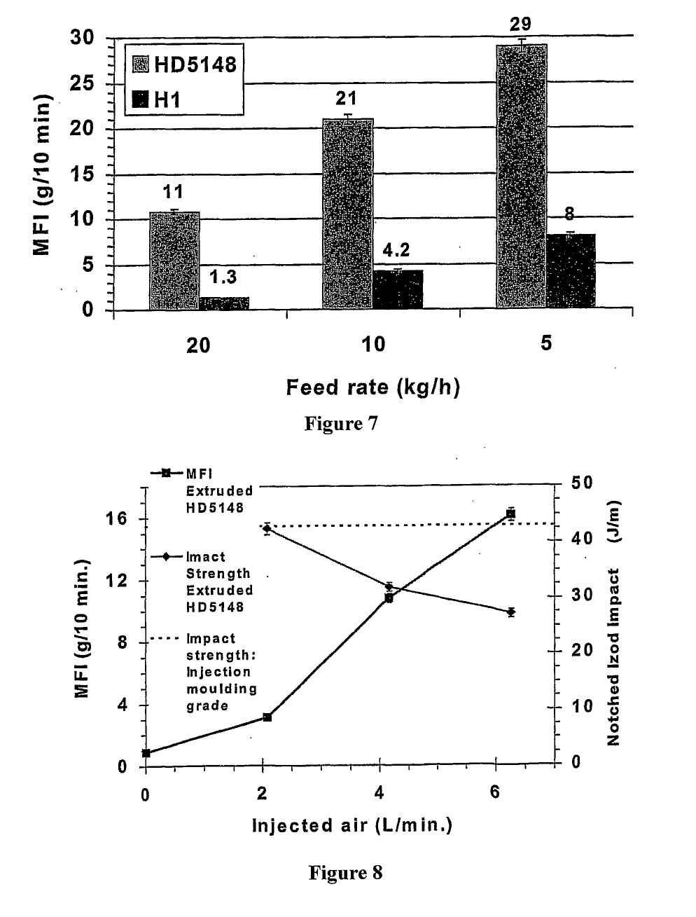

FIG. 7 demonstrates the effect of residence time on the melt flow index of HD5148 and H1 (24 brass elements, 400 rpm, 220° C. and 4 L/min) The results clearly indicate that the MFI of both HD5148 and H1 increases when there is a decrease in the feed rate from 20 kg/hr to 5 kg/hr, which corresponds with an increase in residence (reaction) time from 50 seconds to 3.3 minutes.

### Impact Testing

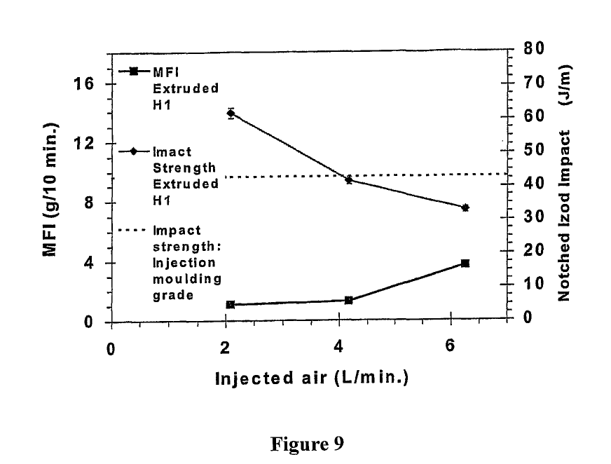

The impact strength of HD5148 and H1 extruded according the present invention was determined with experiments at constant rotational velocity, feed rate and temperature (400 rpm, 20 kg/h and 220° C.) and variable air flow rate (2.1 L/min to 6.2 L/min). FIG. 8 and FIG. 9 illustrate that it is possible to obtain a material with an appropriate rheology and an impact strength resembling that of an injection moulding HDPE grade (i.e. 43 J/m) by selecting a suitable flow rate and other process conditions.

For HD5148, appropriate impact strength was obtained under the conditions used by reactively extruding at a flow rate of around 2 L/min. For H1, an impact strength approaching that of the injection moulding grade and appropriate rheology (i.e. a MFI of around 3.5 g/10 min) may be obtained by operating at higher flow rates such as 6.2 L/min.

### B. Chain Scissioning of Polypropylene

Experiments with polypropylene were carried out using a similar experimental extruder configuration as described above for HDPE. Five sets of brass ring gear mixing elements (total L/D 2.5) were used to provide the source of transition metal catalyst. A polypropylene homopolymer KY6100 (Shell, Canada, MFI of 3.0, density 0.904) was used in the experiments. The effect of using stabilised (commercial pellets) and unstabilised grades (ex reactor powder) and processing at different temperatures was investigated. Extruder rpm 100 and through put was 5 kg/hr for all experiments. The results are set out in table 3 below.

TABLE 3
Chain scissioning of PP KY6100

| Material | Oxygen Source | Temperature | MFI |
|---|---|---|---|
| PP KY6100 | Nil | 200° C. | 5.7 |
| stabilised | 50/50 blend oxygen and nitrogen | 200° C. | 22.4 |
| | injected at rate of 5 g/min | 220° C. | 208 |
| | | 230° C. | 197 |
| PP KY6100 | 50/50 blend oxygen and nitrogen | 220° C. | 373 |
| unstabilised | injected at rate of 5 g/min | | |
| powder | | | |

Experiments with polypropylene were carried out using the similar experimental extruder configuration as described using a polypropylene homopolymer Moplen HP400N (Lyondell/Basell MFI of 11.0, density 0.900) was used in these experiments. Five sets of brass ring gear mixing elements (total L/D 2.5) were used to provide the source of transition metal catalyst. The effect of catalyst composition, polymer throughput rate and gas injection rate (oxygen file) were evaluated. Extruder rpm 100 for all experiments the gas used was a 50% blend of oxygen and nitrogen. The results are set out in table 4 below.

TABLE 4
Chain scissioning of PP HP400N

| | | Oxygen | | | catalyst |
|---|---|---|---|---|---|
| Polymer | throughput | Flow | Temperature | MFI | source |
| PP HP400N | 5 kg/hr | Nil | 220° C. | 11.47 | brass |
| | 5 kg/hr | 5 g/min | 220° C. | 80 | brass |
| | 3.5 kg/hr | Nil | 220° C. | 12.6 | copper |
| | 3.5 kg/hr | 3 g/min | 220° C. | 107 | copper |
| | 3.5 kg/hr | Nil | 220° C. | 13.6 | bronze |
| | 3.5 kg/hr | 2 g/min | 220° C. | 92 | bronze |
| | 3.5 kg/hr | 3 g/min | 220° C. | 76, 68, | bronze |
| | | | | 18, 90^{a} | |
| | 5 kg/hr | 1 g/min | 220° C. | 19.4 | bronze |
| | 8 kg/hr | 2 g/min | 220° C. | 71 | bronze |

^{a}4 determinations were made.

### C. Chain Scissioning of LLDPE

Experiments with LLDPE were then carried out using the same experimental equipment (extruder set-up and MFI measurements etc) as the examples described above. Five sets of brass ring gear mixing elements (total L/D 2.5) were used to provide the source of transition metal catalyst. The experimental material used, Equistar GA501 is an ethylene-butylene copolymer which is prepared using the Unipol process. The effect of using stabilised and unstabilised grades was investigated with similar results. Equistar GA501 has a MFI of 1.0. The results are set out in table 5 below.

TABLE 5
Chain scissioning of LLDPE Equistar GA501

| Polymer | Oxygen flow | Temperature | MFI |
|---|---|---|---|
| LLDPE Equistar | Air injected at rate of 5 g/min | 270° C. | 3.98 |
| GA501 | | | |
| | 50/50 blend oxygen and nitrogen | 270° C. | 18.1 |
| | injected at rate of 5 g/min | | |
| LLDPE Equistar | Air injected at rate of 5 g/min | 270° C. | 3.91 |
| GA501 | | | |
| unstabilised | | | |
| powder | | | |

Throughout this specification and the claims which follow, unless the context requires otherwise, the word “comprise”, and variations such as “comprises” and “comprising”, are not intended to exclude other additives, components, integers or steps.

1. A process for increasing the melt flow index of a polyolefin, the process comprising using a melt mixing device to melt mix the polyolefin in contact with oxygen and a transition metal catalyst having a redox potential ranging from 0 to 2 volts, wherein oxygen is introduced to the melt mixing device, and wherein the transition metal catalyst in contact with the polyolefin forms at least part of a component of the melt mixing device.

2. The process according to claim 1, wherein the transition metal catalyst has a redox potential ranging from about 0.2 to about 1.

3. The process according to claim 1, wherein the transition metal catalyst comprises copper.

4. The process according to claim 3, wherein the copper is in its metallic state.

5. The process according to claim 4, wherein the copper forms part of an alloy.

6. The process according to claim 5, wherein the alloy is brass or bronze.

7. The process according to claim 1, wherein the polyolefin is polyethylene or polypropylene homopolymer or copolymer.

8. The process according to claim 1, wherein said component is a mixing element of the melt mixing device.

9. The process according to claim 8, wherein the melt mixing device is a screw extruder and the mixing element forms part of the screw.

10. The process according to claim 8, wherein the mixing element is made of copper or an alloy comprising copper, or is coated with copper or an alloy comprising copper.

11. The process according to claim 8, wherein the mixing element is made of brass or bronze.

12. The process according to claim 1, wherein the oxygen is introduced to the melt mixing device using a compressed gas cylinder or a pump.

13. The process according to claim 12, wherein the source of oxygen is air or a mixture of oxygen and nitrogen gas.

14. The process according to claim 1, wherein the increase in melt flow index of the polyolefin is controlled by controlling one or more process features selected from residence time of the polyolefin in the melt mixing device, shear applied to the polyolefin by the melt mixing device, temperature at which the polyolefin is melt mixed and the pressure and/or concentration of oxygen introduced to the melt mixing device.

15. A moulded article obtained by injection moulding a polyolefin prepared by a process as claimed in claims 1.
